(19) United States
(12) Patent Application Publication
(10) Pub. No.: US 2009/0056101 A1
(43) Pub. Date: Mar. 5, 2009

(54) METHOD FOR SECURING A THREADED INSERT IN A THREADED OPENING

(75) Inventors: Jonathan K. Cuddy, Winnipeg (CA); Roy Willerton, Winnipeg (CA)

Correspondence Address: MCDERMOTT WILL & EMERY LLP, 28 STATE STREET, BOSTON, MA, 02109-1775, US

(73) Assignee: Standard Aero Limited, Winnipeg (CA)

(21) Appl. No.: 11/846,834

(22) Filed: Aug. 29, 2007

(51) Int. Cl. B23P 19/04

(52) U.S. Cl. 29/456

(57) ABSTRACT

A method for securing, in an opening, an insert or a helical coil, comprising means for fusing the coil, wherein fine laser welds are provided, in an individual or overlapping pattern added, on one or more than one turns of the coil.

### FIELD OF THE INVENTION

The present invention relates, generally, to a method for securing a threaded insert installed in a threaded opening within a substrate or parent material. Specifically, the present invention relates to a method for repairing a threaded opening using a helical coil. More specifically, the present invention relates to a method for repairing a steel stubshaft used in a gas turbine engine.

### BACKGROUND OF THE INVENTION

A helical coil is a type of insert which, when installed in a threaded opening within a substrate or parent material, provides strengthened and precision-shaped internal screw threads. Due to their reliability and ease of use, helical coils are widely used in a variety of materials and applications, both for the original manufacture of components and for repair of components having damaged threads.

Helical coils are available in a variety of sizes and are selected to be slightly larger, in their free state, than the diameter of the threaded opening. Helical coils have an inherent springiness such that, once installed, the coils expand outward and exert pressure on the mating threads of the substrate. This outward pressure creates a frictional force that tends to retain the coils in the threaded opening while in use.

Helical coils are typically employed on assemblies with mating screws, bolts, studs and other types of fasteners. Considerable testing has been performed to show that this type of arrangement will remain secure under a number of operating conditions. For example, Heli-coil™ Technical Bulletin 71-2, from Emhart Teknologies, discloses acceptable performance of heli-coil™-fastener assemblies under conditions of shock, vibration and fatigue loading. There is however, a lack of published test data to support the retention of a helical coil itself, when installed alone and without a mating fastener or other means of confinement, in components subject to various operational stresses. In particular, there is little evidence to support the retention of a helical coil itself, when installed alone in high speed rotating components subject to vibration, centrifugal forces and temperature variations as found, for example, in gas turbines.

The problem of fastening a helical coil or other type of insert has been considered in the prior art, but in a much different context. U.S. Pat. No. 3,943,587 to Lasky and U.S. Pat. No. 4,040,462 to Hattan both describe methods for manufacturing a threaded nut, whereby a coil is welded to the inner surface of a smooth cylinder (referred to as nut casing), and the mating outer surface of the coil is also made smooth to facilitate mating and joining of the two components. In both cases the weld is applied to the full or nearly full cylindrical interface between the parts, and the coil becomes permanently embodied in a now unitary structure. U.S. Pat. No. 6,276,883 to Unsworth et al. describes a self-adjusting screw system whereby a coil or helical coil is temporarily attached to the outer threads of a screw, and is then released during, or a short time after, installation of the screw-coil assembly into a substrate.

While the above-identified patents have considered the use of helical coils in the fabrication of a new article or system, there is no teaching in the prior art that describes a method of retaining or securing a threaded insert, particularly a helical coil, when installed in a threaded opening in a component subject to various stresses, such as those induced by rotation, vibration and thermal fluctuations.

### SUMMARY OF THE INVENTION

In view of the foregoing an object of the present invention is to provide a means for securing a threaded insert once installed in a threaded opening within a substrate or a parent material.

In accordance with an aspect of the present invention, there is provided a method for securing a threaded insert in a parent material, the method comprising the steps of: drilling an opening partially within or completely through the parent material; tapping an internal thread on an inner surface of the opening; placing the insert in the opening; and uniting the edge of the insert to the parent material by a means for applying a fine spot weld.

In accordance with another aspect of the present invention there is provided a method for securing a threaded insert in an opening within a parent material and/or repairing an opening, the method comprising the steps of: optionally, drilling the threaded opening to a larger size opening and tapping an internal thread on an inner side of the larger size opening; and/or placing the insert in the opening; and uniting the edge of the insert to the parent material by a means for applying a fine spot weld.

In accordance with a further aspect of the present invention there is provided a use of the method for securing a threaded insert in a threaded opening and/or for repairing an opening, more specifically for repairing a stubshaft used in a gas turbine.

### BRIEF DESCRIPTION OF THE DRAWINGS

Exemplary, embodiments of the present invention will now be described in conjunction with the accompanying drawings, in which:

FIG. 1 shows a cross-sectional view of a helical coil according to the present invention inserted in a threaded opening through a substrate or parent material;

FIG. 2a shows a top plan elevational view of individual welds applied according to a representative pattern to the helical coil-threaded opening interface according to the present invention; and

FIG. 2b shows a top plan elevational view of overlapping welds applied according to a representative pattern to the helical coil-threaded opening interface according to the present invention.

### DETAILED DESCRIPTION OF THE DRAWINGS

The following description is presented to enable a person skilled in the art or science to which the present invention pertains to make and use the invention, and is provided in the context of a particular application and its requirements. Various modifications to the disclosed embodiments will be readily apparent to those skilled in the art or science, and the general principles defined herein may be applied to other embodiments and applications without departing from the spirit and scope of the invention. Thus, the present invention is not intended to be limited to the embodiments disclosed, but is to be accorded the widest scope consistent with the principles and features disclosed herein. It is to be understood that each specific term includes all technical equivalents which operate in a similar manner to accomplish a similar purpose.

The term threaded insert is used herein to refer to a coiled wire insert and/or any insert suitable for insertion into a threaded opening and should be not be regarded as limited to helical coils. The terms “helical coil” or “coil” are used interchangeably herein and refer to a spiral-wound wire, preferably with a diamond shape. In a preferred embodiment, the inner and outer edges of the helical coil define a screw thread.

The method of the present invention is advantageous as a means for securing or retaining any threaded insert, and in particular a helical coil, installed in a parent material or substrate. The method of the present invention is particularly advantageous for repairing a threaded opening within a parent material, and specifically, for repairing a steel stubshaft in a gas turbine engine. However, it is envisaged that the present invention may be suitable for securing a threaded insert, preferably a helical coil, installed in a threaded opening in any metallic component that may be subject to various stresses, such as those induced by rotation, vibration, and/or thermal fluctuations.

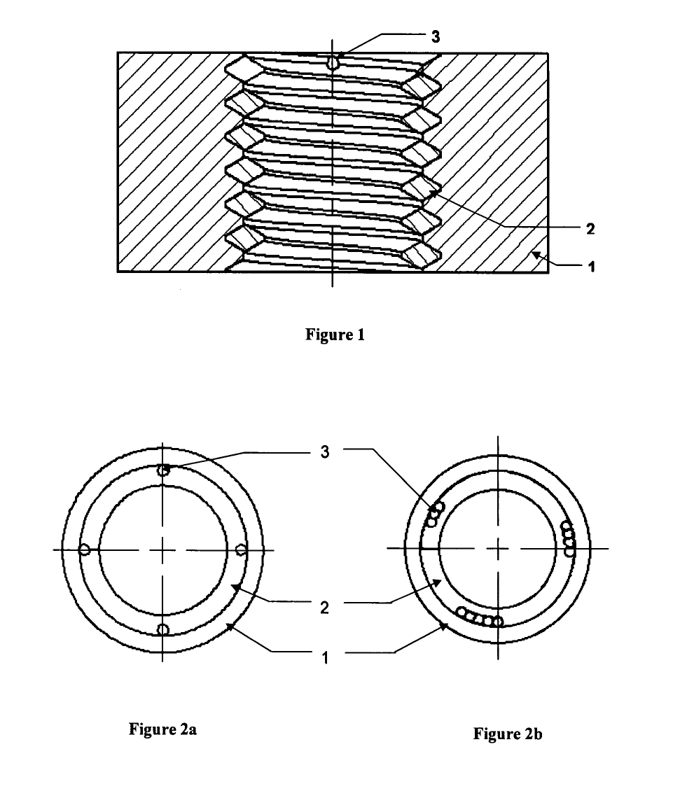

Referring to FIG. 1, shown is a cross-sectional depiction of a helical coil installation in a threaded article. In accordance with the invention, a hole or recess is drilled and tapped into a substrate 1, and an appropriately sized helical coil 2 is installed using tools and methods for helical coil installation that are well-known to a person skilled in the art pertaining to the subject invention. In a preferred embodiment the internal thread of the opening is engageably connected with the thread of the outer surface of the helical coil. The edge of the helical coil is then fused to the substrate thread using fine laser spot welds 3. The welds may be applied individually or in an overlapping pattern, on one or more than one turns of the coil. However, other patterns such as individual welds, intermittent or continuous overlapping welds applied to one or more than one turns of the helical coil are envisioned.

A representative pattern of single welds applied to the helical coil-threaded opening interface is illustrated in a top plan view shown in FIG. 2a. Another representative pattern of overlapping welds applied to the helical coil-threaded opening interface is illustrated in FIG. 2b. As illustrated in the above-identified figures the welds may be applied to points that correspond to the vertices of a polygon inscribed in the circle defined by the threaded opening 1. Any number of weld application patterns may be also envisioned beyond the examples shown in FIGS. 2a and 2b, including single and overlapping welds with even or uneven circumferential spacing, and with equal or unequal numbers of overlapping spot welds.

With the helical coil inserted in the threaded opening, a welding technique, preferably one that produces a localized fusion may be applied to unite the helical coil to the substrate or parent material. The technique may be used to create a solid, metallurgical bond between the installed helical coil and the substrate thread. The technique locally fuses the coil to the substrate thread without affecting the overall dimensional, metallurgical or mechanical properties of the coil or substrate material, except in the immediate vicinity of the weld. The inner surfaces of the coil which comprise the functional internal thread remain unaffected. The weld itself and surrounding material affected by it comprise an area approximately 0.25 to 1.0 mm (0.010″ to 0.040″), in diameter on the surface, and approximately 0.15 to 0.45 mm (0.006″ to 0.018″) in depth below the surface.

The localized fusion is preferably achieved using a high energy density beam that can be precisely aimed and controlled, such as laser or electron beam, however other means of welding may also be employed such as GTAW, micro-TIG, micro-plasma, resistance or capacitive-discharge welding, etc.

The technique can be applied to all available sizes of standard, free-running helical coils, as well as other types including tangless, screw-lock, hi-torque, stud-lock, double or twinserts and oversized helical coils. The general technique defined herein may also be applied to other types of threaded inserts such as keenserts or key inserts, slimserts, and various threaded bushings. It can be used on a variety of helical coil and threaded insert materials, including but not limited to stainless steel, Inconel X750, Nitronic 60, titanium, Nimonic 90 and Phosphor-bronze. The technique is applicable to a wide range of substrate materials, such as ferrous alloys, stainless steels, nickel-base and cobalt-base alloys, titanium, aluminum and magnesium. The insert and substrate materials may be of the same composition or different composition and/or in the same or different heat treated condition.

If so desired, a heat treatment may be applied after welding to relieve localized stresses and produce greater uniformity in hardness and other properties in the immediate areas affected by the weld. The heat treatment cycle can be chosen so as to not affect the bulk properties of the materials involved.

The same technique may be applied to repair damaged or oversized threads in an article, whereby the damaged material is drilled out and tapped, and a helical coil installed and welded as previously described.

A welded coil may be removed from the article at a later date if required due to deterioration of the coil itself, or to facilitate inspection of the underlying substrate threads. This can be accomplished using coil extraction devices well known to the art. One such tool consists of a small shaft with a wedge-shaped end provided with hard, sharpened edges. The edges are set into the inner radial surfaces of the coil with a small blow from a mallet, and then torque is applied with the tool to break the weld(s) and unscrew the coil.

### EXAMPLE 1

Various applications of the present invention may be envisaged. In the present example, the invention is applied for repairing a steel stubshaft used in a gas turbine engine. The stubshaft is a high speed rotating component that transmits power and torque between the compressor and turbine modules. The stubshaft incorporates a flange on its outer periphery, which is furnished with a series of threaded holes or openings to which small weights may be attached. These weights are affixed to some, but not all, of the holes in order to dynamically balance the rotating component at the time of assembly, and thus reduce vibration while in operation. To prevent them from loosening over time, the balance weights are retained in the threaded holes using locking tab washers. The threads on the balance weight holes often become damaged as a result of excessive wear or corrosion from service. Repair of a damaged stubshaft balance weight hole was accomplished by drilling out the damaged material, tapping to create a larger thread size, and then installing a helical coil so as to restore the original thread size and form. If the repaired hole receives a balance weight when the component is balanced, then the helical coil and balance weight will be retained in the hole by the aforementioned locking tab washer. Since it is not known ahead of time whether this condition will be met or not, a positive means of securing the helical coil is required to ensure that it does not loosen when subject to operating conditions. In this repair, retention of the helical coil was achieved by spot welding the coil to the balance weight hole threads using a pulsed Nd:YAG laser. The welds were precisely located such that only the immediate area of the coil to thread interface was fused, without affecting the inner radial surfaces of the coil that form the functional thread. This was verified by inspecting the thread, and successfully installing a balance weight in the repaired hole to a specified assembly torque. After welding, the part was heat treated to reduce residual stresses from welding and temper the weld and adjacent heat-affected material.

Test 1

A test was devised to quantify the degree of retention obtained by laser spot welding the helical coils. Stainless steel helical coils were installed in threaded holes in a steel plate, and then secured to the threads using laser spot welds. The spot welds were applied to one end of the coils using an overlapping pattern similar to that shown in FIG. 2b. A steel bolt was then screwed into one of the holes such that the end of the bolt was approximately flush with the unwelded end of the coil, and then laser welding was used to fuse the entire periphery of the bolt end to the coil. Torque was then applied to the bolt using a standard torque wrench equipped with dial indicator, such that the applied torque was transferred directly to the spot welds joining the coil to the substrate threads. The torque was increased until the spot welds broke, and the “break-away” torque recorded. The test was repeated on 5 additional welded helical coils to obtain a representative sample size. For the purpose of comparison, the same test was also performed on helical coils which had not been welded to the substrate threads. The results of the test found that the break-away torque for welded helical coils was approximately 8 times higher than that of unwelded helical coils.

All patents and patent applications mentioned in this specification are indicative of the level of skill of a person having an ordinary skill in the art to which this invention pertains, and are herein incorporated by reference to the same extent as if each individual publication or patent application was specifically and individually indicated to be incorporated by reference.

We claim:

1. A method for securing an insert in a parent material, the method comprising the steps of:
a) drilling an opening into the parent material;
b) tapping an internal thread on an inner side of the opening;
c) placing the insert in the opening; and
d) uniting the edge of the insert to the parent material by a means for applying a fine spot weld.

2. A method according to claim 1, wherein the weld is applied to points that correspond to the vertices of a polygon inscribed in the circle defined by the opening.

3. A method according to claim 1, wherein a pattern of weld points is symmetrical or asymmetrical, the pattern comprising single or overlapping welds, with even or uneven circumferential spacing, and with equal or unequal number of overlapping welds.

4. A method according to claim 1, wherein the weld is from about 0.25 to about 1.0 mm in diameter on the surface of the opening and from about 0.15 to about 0.45 mm in depth below the surface of the opening.

5. A method according to claim 1, wherein the weld is applied individually.

6. A method according to claim 1, wherein the weld is applied in an overlapping pattern with even or uneven circumferential spacing, and with equal or unequal number of overlapping welds.

7. A method according to claim 1, wherein the insert is shaped to form a thread and has a plurality of turns.

8. A method according to claim 7, wherein the weld is applied on one or more than one turns of the insert.

9. A method according to claim 1, wherein the insert is a helical coil.

10. A method according to claim 9, wherein the helical coil has a diamond shape.

11. A method according to claim 8, wherein the internal thread of the opening is engageable with the thread of the insert.

12. A method according to claim 1, wherein the means for applying the weld is selected from the group consisting of laser, micro-GTAW, micro-PTAW, micro-TIG, electron beam, resistance welding, or micro-plasma.

13. A method according to claim 12, wherein the laser is a pulsed Nd:YAG laser.

14. A method for securing an insert in an opening in a parent material, the method comprising the steps of:
a) placing the insert in the opening; and
b) uniting the edge of the insert to the parent material by a means for applying a fine spot weld.

15. A method according to claim 14, wherein the opening is a threaded opening.

16. A method according to claim 15 further comprising the steps of:
a) drilling the threaded opening to a larger size opening; and
b) tapping an internal thread on an inner side of the larger size opening.

17. A method according to claim 14, wherein the weld is applied to points that correspond to the vertices of a polygon inscribed in the circle defined by the opening.

18. A method according to claim 14, wherein a pattern of weld points is symmetrical or asymmetrical, comprising single or overlapping welds with even or uneven circumferential spacing, and with equal or unequal number of overlapping welds.

19. A method according to claim 14, wherein the weld is from about 0.25 to about 1.0 mm in diameter on the surface of the opening and from about 0.15 to about 0.45 mm in depth below the surface of the opening.

20. A method according to claim 14, wherein the weld is applied individually.

21. A method according to claim 14, wherein the weld is applied in an overlapping pattern with even or uneven circumferential spacing, and with equal or unequal number of overlapping welds.

22. A method according to claim 14, wherein the insert is shaped to form a thread and has a plurality of turns.

23. A method according to claim 22, wherein the weld is applied on one or more than one turns of the insert.

24. A method according to claim 14 wherein the insert is a helical coil.

25. A method according to claim 24, wherein the helical coil has a diamond shape.

26. A method according to claim 23, wherein the internal thread of the opening is engageable with the thread of the insert.

27. A method according to claim 14, wherein the means for applying the weld is selected from the group consisting of laser, micro-GTAW, micro-PTAW, micro-TIG, electron beam, resistance welding, or micro-plasma.

28. A method according to claim 27, wherein the laser is a pulsed Nd:YAG laser.

29. Use of the method according to claim 1 for repairing a steel stubshaft used in a gas turbine.

30. Use of the method according to claim 14 for repairing a steel stubshaft used in a gas turbine.
